(19) United States
(12) Patent Application Publication
(10) Pub. No.: US 2026/0358987 A1
(43) Pub. Date: Nov. 12, 2026

(54) INTERCEPTING A PRINT JOB TO OFFER SIGNIFICANT PREVIEW, EDITING, AND RE-ROUTING OPTIONS

(71) Applicant: XEROX CORPORATION, NORWALK, CT (US)

(72) Inventors: Jonathan A. EDMONDS, Silverton, OR (US); Jeremy GRIFFITH, Rochester, NY (US)

(73) Assignee: XEROX CORPORATION, NORWALK, CT (US)

(21) Appl. No.: 19/204,229

(22) Filed: May 9, 2025

(51) Int. Cl. G06F 3/12

(52) U.S. Cl. CPC G06F 3/1208; G06F 3/1204; G06F 3/1256; G06F 3/1247; G06F 3/1288

(57) ABSTRACT

A method, a system, and a non-transitory computer-readable storage medium having instructions recorded thereon are provided. A print job is intercepted or routed to an intercept application, thereby causing the print job to be paused. A user interface is displayed on a display device and offers a user a selection of an option from among multiple options. The options include one or more of performing advanced previewing of the print job to alter a preview of the print job, and editing content of the print job. The selection of the one of the options is received from the user and operations corresponding to the selection of the one of the options are performed. A document corresponding to the print job is then electronically distributed.

### TECHNICAL FIELD

The present teachings relate generally to interception of a print job while in a print path in order to offer significant preview, editing, and rerouting options.

### BACKGROUND

Once a print command is initiated on a computer to print a document, a print job is created in a print path that cannot be interrupted. As a result of the initiation of the print command, the application from which the print command was initiated arranges content of the print job for printing and provides the print job to a print subsystem. The print subsystem provides the print job to a print driver, which further provides the print job to a printer for printing.

Currently, once a user indicates a desire to print a document, a print preview of the document may be displayed. If the user happens to notice a typographical or other type of error in the print preview, a print command may be canceled and an editing program may be used to make and save a correction to the document before the user again indicates a desire to print the document.

The print preview of the document is actually a proxy of what a printout of the document may look like. Once the document is actually printed, the printout may vary quite a bit from the print preview.

If there is a problem with a printer to which the print job is sent, the user may abort or cancel the print job, thereby terminating the print path, and the user may initiate a print command to create another print job to print to a different printer.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method is provided for intercepting a print job and providing a user interface to allow a user to select one of a number of options to be performed. A processor intercepts the print job causing the print job to be paused. The processor displays the user interface, which offers the user a selection of one option from among a number of options. The options include one or more of performing advanced previewing of the print job to alter a preview of the print job, and editing content of the print job. The selection of the one option is received from the user and operations corresponding to the one of the selected options are performed while the print job is in a print path. The document corresponding to the print job is electronically distributed.

A system is provided. The system includes at least one processor, a respective memory connected with each of the at least one processor, and a display device connected with one of the at least one processor, wherein a group of the respective memory connected with the each of the at least one processor collectively include processor instructions to perform operations. The operations include intercepting of a print job, the intercepting causing the print job to be paused. The display device displays a user interface that offers the user a selection of one option of a number of options. The options include one or more of performing advanced previewing of the print job to alter a preview of the print job, and editing content of the print job. The selection of the one option of the number of options is received from the user and operations corresponding to the selection of the one option are performed while the print job is in the print path. A document corresponding to the print job is electronically distributed.

A non-transitory computer-readable storage medium having instructions recorded thereon is provided. When the instructions are executed by one or more processors, operations are performed. The operations include intercepting of a print job, the intercepting causing the print job to be paused. The display device displays a user interface that offers the user a selection of one option of a number of options. The options include one or more of performing advanced previewing of the print job to alter a preview of the print job, and editing content of the print job. The selection of the one option of the number of options is received from the user and operations corresponding to the selection of the one option are performed while the print job is in the print path. A document corresponding to the print job is electronically distributed.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts an example environment in which embodiments of the subject of this disclosure may operate.

FIG. 2 is a functional block diagram of a computing device that may implement various embodiments.

FIG. 3 is a flowchart of a prior art process for creating and executing a print job.

FIG. 4 is a flowchart of a process for creating and executing a print command according to various embodiments.

FIG. 5 is an example display of a user interface that may be displayed when a user indicates a desire to print a document according to embodiments.

FIG. 6 is an example display that includes a print preview and a number of options that a user may select according to some embodiments.

FIG. 7 shows an enlarged view of a portion of the display shown in FIG. 6.

FIG. 8 is an example display regarding adding of a signature to a document represented in a print preview.

FIG. 9 is an example display regarding adding of a date to a document represented in a print preview.

FIG. 10 is an example display for changing a printer while in a print path.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

In various embodiments of the present disclosure, when a print command is issued to print a document, a print job for printing the document may be created and a PDF of the document may be rendered. The print job may be paused and the PDF associated with the print job may be routed to an intercept application that applies additional processing before printing or rerouting the print job to other services. For example, in some embodiments the created PDF may be routed to the intercept application where processing may occur such as, for example, post-processing of the PDF, such as creating a booklet or adding annotations or watermarks or perhaps removing pages that meet select criteria, or making the document use less ink, etc. The PDF then may be routed to one of a number of cloud applications for further processing. The cloud applications may include services such as, for example, translation of a first language of the PDF to a second language, creation of an audio file corresponding to text in the PDF file, creation of a summary from the PDF file, merging the PDF file with another PDF file, converting handwriting in the PDF file to text, providing for redaction of certain text in the PDF file, as well as other services.

In addition, value-added print settings may be implemented in various embodiments. The value-added print settings may include, but not be limited to settings such as, for example, settings for removing blank pages, creating a booklet, adding annotations or watermarks, removing pages that meet select criteria, making a printout use less ink, etc. If “remove blank pages” is selected, a sensitivity setting of an app for removing blank pages may be set. For example, the sensitivity setting may include “conservative”, “somewhat conservative”, “balanced”, “somewhat aggressive”, and “aggressive”. As a result of setting “remove blank pages”, a displayed print preview may indicate which pages of the document are considered blank and will be removed from a printout.

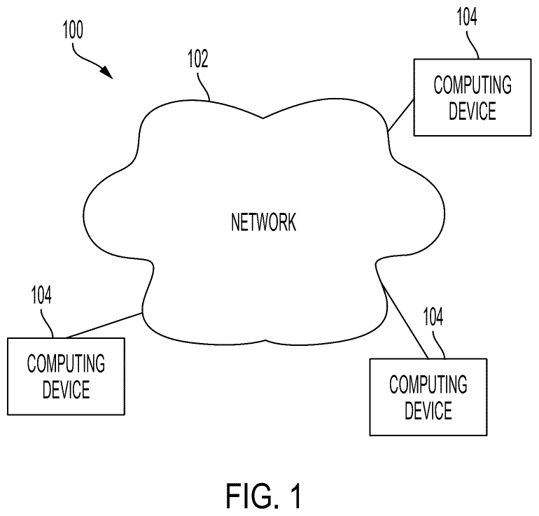

FIG. 1 illustrates an exemplary operating environment 100 for an embodiment consistent with subject matter of this disclosure. Operating environment 100 may include computing devices 104 and network 102.

Computing devices 104 may be, for example, desktop computing devices, laptop computing devices, handheld computing devices, servers or other computing devices. At least one computing device 104 may be a user computing device from which a user may initiate a print command for printing a document.

Although FIG. 1 shows three computing devices 104, other operating environments may have more or fewer computing devices 104.

Network 102 may be a wired or wireless network and may include a number of devices connected via wired or wireless means. Network 102 may include only one network or a number of different networks, some of which may be networks of different types. Network 102 may include a packet-switching network, a wireless network, an ATM network, a Frame Relay network, an optical network, a Public Switched Telephone Network (PSTN), a satellite network, the Internet, or an intranet or other types of networks, or any combination of the above networks.

In implementations consistent with the subject matter of this disclosure, a user computing device may communicate with a local printer to print a document or request a service, or may communicate with one or more other computing devices 104 to print a document remotely or to request a service.

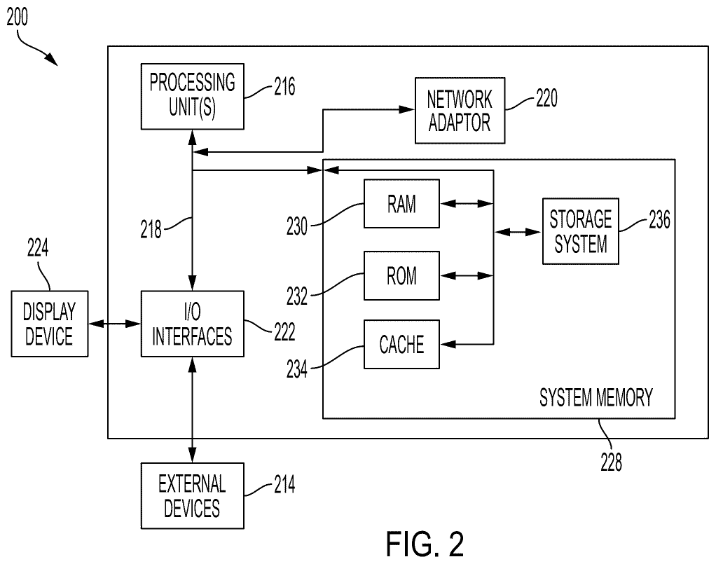

FIG. 2 is a functional block diagram of a computing system 200 that may implement any of computing devices 104. Computing system 200 is shown in a form of a general-purpose computing device. Components of computing system 200 may include, but are not limited to, one or more processing units 216, a system memory 228, and a bus 218 that couples various system components including system memory 228 to one or more processing units 216.

Bus 218 represents any one or more of several bus structure types, including a memory bus or memory controller, a peripheral bus, an accelerated graphics port, and a processor or local bus using any of a variety of bus architectures. Such architectures may include, but not be limited to, Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computing system 200 may include various non-transitory computer-readable media, which may be any available non-transitory media accessible by computing system 200. The computer-readable media may include volatile and non-volatile non-transitory media as well as removable and non-removable non-transitory media.

System memory 228 may include non-transitory volatile memory, such as random access memory (RAM) 230 and cache memory 234. System memory 228 also may include non-transitory non-volatile memory including, but not limited to, read-only memory (ROM) 232 and storage system 236. Storage system 236 may be provided for reading from and writing to a nonremovable, non-volatile magnetic medium, which may include a hard drive or a Secure Digital (SD) card. In addition, a magnetic disk drive, not shown, may be provided for reading from and writing to a removable, non-volatile magnetic disk such as, for example, a floppy disk, and an optical disk drive for reading from or writing to a removable non-volatile optical disk such as a CD-ROM, DVD-ROM or other optical media. Each memory device may be connected to bus 218 by at least one data media interface. System memory 228 further may include instructions for processing unit(s) 216 to configure computing system 200 to perform functions of embodiments. For example, system memory 228 also may include, but not be limited to, processor instructions for an operating system, at least one application program, other program modules, program data, and an implementation of a networking environment.

Computing system 200 may communicate with one or more external devices 214 including, but not limited to, one or more displays, a keyboard, a pointing device, a printer, a speaker, at least one device that enables a user to interact with computing system 200, and any devices including, but not limited to, a network card, a modem, etc. that enable computing system 200 to communicate with one or more other computing devices. The communication can occur via Input/Output (I/O) interfaces 222. Computing system 200 can communicate with one or more networks including, but not limited to, a local area network (LAN), a general wide area network (WAN), a packet-switched data network (PSDN) and/or a public network such as, for example, the Internet, via network adapter 220. As depicted, network adapter 220 communicates with the other components of computer system 200 via bus 218.

It should be understood that, although not shown, other hardware and/or software components could be used in conjunction with computer system 200. Examples, include, but are not limited to, microcode, device drivers, redundant processing units, external disk drive arrays, RAID systems, tape drives, and data archival storage systems, etc.

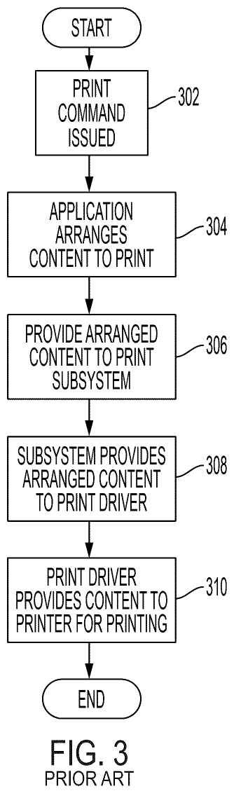

FIG. 3 is a flowchart that explains example processing that may occur in a prior art computer system when a user causes a print command to be issued to print a document. The process may begin with the print command being issued (act 302). The application from which the print command is issued then may arrange content of a document for printing (act 304). The application then may provide the arranged content to a print subsystem (act 306), which provides the arranged content to a print driver (act 308). Finally, the print driver may provide the arranged content to a printer for printing (act 310).

Once the print process of FIG. 3 is initiated, the content to print may be previewed, but cannot be captured and routed to any other services or processes other than those mentioned with respect to the flowchart of FIG. 3.

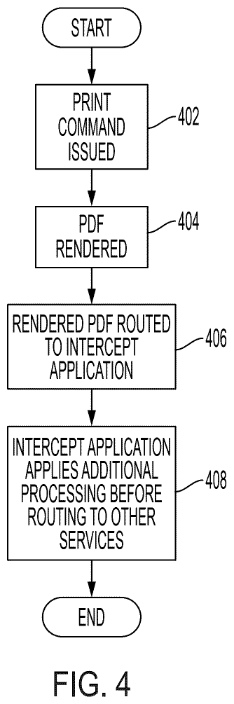

In contrast to the process shown in FIG. 3, FIG. 4 is a flowchart of a process that may be performed in embodiments of the subject matter of this disclosure. The process may begin with a print command being issued to print a document (act 402). In response to the issuing of the print command, a PDF of the document may be rendered (act 404). The rendered PDF may be routed to an intercept application (act 406), which may apply additional processing to the rendered PDF before possibly routing the PDF to other services. In various embodiments, the additional processing may include, but not be limited to, scanning for security issues, archiving for posterity, providing suggested alternatives to printing in a displayed toast notification, providing an explanation of cost in a displayed toast notification, etc. Optionally, the rendered PDF may be provided to a print subsystem and to a print driver for printing after the rendered PDF is routed to any of the other services (not shown).

When a print command is issued, a print preview of a document may be displayed to show how a printout of the document may appear. Embodiments of the subject of this disclosure may actually display how the printout would appear. This is possible because the print preview is based on the PDF that is rendered when the print command is issued. Print-ready content is communicated to a printer in PDF format.

In contrast, many prior art computing devices used page description languages such as PostScript and PCL for communicating print-ready content to printers. This resulted in a printout that did not always look identical to a document.

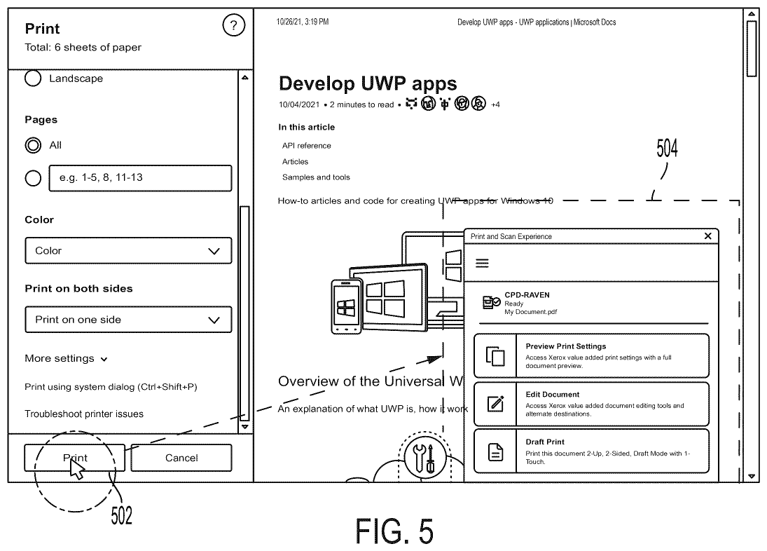

In various embodiments, when a user indicates a desire to print a document from a computing device 104, a PDF of the print document is rendered and displayed as a print preview and the rendered PDF is routed to an intercept application. The intercept application may cause a number of value-added options to be displayed. FIG. 5 shows an example display in which a user selected a print control 502. As a result of selecting print control 502, a user interface 504 may be displayed providing a number of options from which the user may select. In the example display of FIG. 5, three options are shown: a first option for viewing and changing print preview settings; a second option for editing a document shown in a print preview; and a third option for performing a draft print of a document shown in a print preview. In other embodiments, more or fewer options may be shown as well as different options.

In the embodiment of FIG. 5, the draft print of the document would be printed two page images per page (2-up) and 1-touch indicates an ability to select a single control to apply one or more settings and print in a single action.

When the first option is selected, print settings may be shown, which may include, but not be limited to, secure print, duplex, booklet, paper size, staple, punch, fold, print quality, annotations, etc. When the second option is selected, a user is allowed to edit the PDF document in select ways with features including, but not limited to, adding signatures, rotating a page, removing pages, adding new pages, and highlighting or marking up a page. The editing may include adding a header or footer to a current page of the document shown in the print preview or to every page of the document.

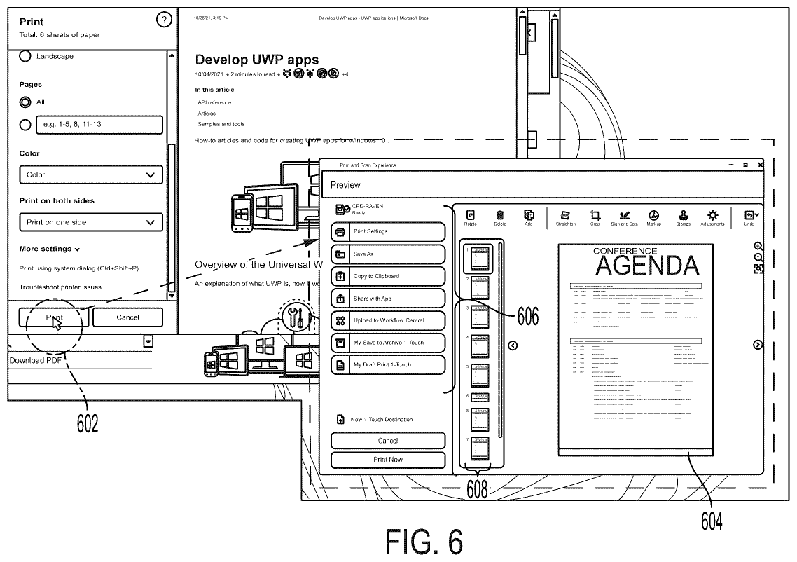

FIG. 6 shows an example display in another embodiment. In FIG. 6, a print preview 604 of a document is displayed after a user selects print control 602. A user interface of the print preview shows a number of options 606 that may be selected by a user using, for example, a pointing device, which could be a computer mouse, a user's finger on a touch screen, and the like. The options may include “print settings”, “save as”, “copy to clipboard”, “share with app”, “upload to workflow central”, “my save to archive 1-touch”, and “my draft print 1-touch”.

When selected, “print settings” displays current value-added settings. The value-added settings may include, but not be limited to, remove blank pages, secure print, paper size, duplex, booklet, staple, punch, fold, print quality, and annotations. A user may select a value-added print setting using a pointing device and may change the print setting. When selected, “save as” causes the user to be prompted for a file name and a folder for saving the previewed document. The previewed document then may be saved to the folder in a file with the provided file name. When selected, “copy to clipboard” may cause the previewed document to be saved to a clipboard. When selected, “share with app” will allow the previewed document to be shared with a specific app specified by the user. When selected, “upload to workflow central” may cause a copy of the previewed document to be uploaded to an app that may provide a number of services including, but not limited to, language translation, document conversion, and storage to a cloud. When selected, “my save to archive 1-touch” may cause a copy of the previewed document to be saved to an archive. When selected, “my draft print 1-touch will cause the document to be modified before printing to reduce an amount of toner to print the document by reducing a density of the printed images and text.

Thumbnails 608 are thumbnails of pages of the print preview. By selecting a thumbnail 608, a page corresponding to the thumbnail 608 is displayed in the print preview 604.

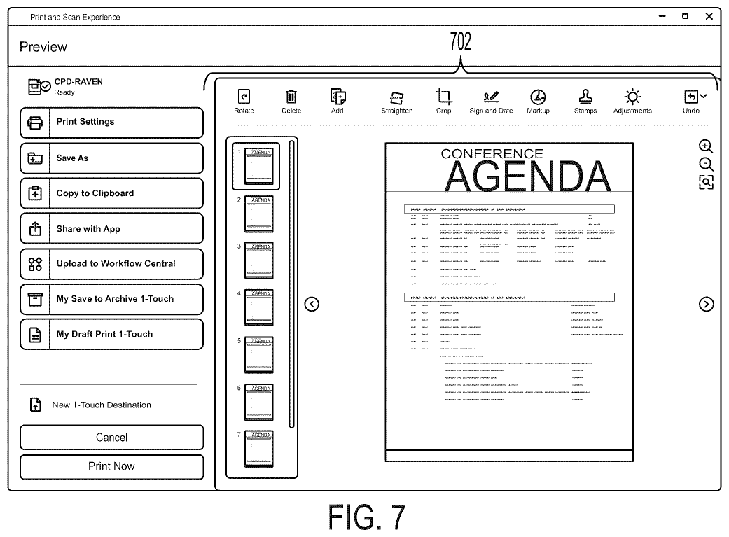

FIG. 7 shows an enlarged portion of the display of FIG. 6. As shown in FIG. 7, controls 702 provide different features that may be applied to a document shown in the print preview. The features shown in FIG. 7 include “Rotate”, “Delete”, “Add”, “Straighten”, “Crop”, “Sign and Date”, “Markup”, “Stamps”, “Adjustments”, and “Undo”. Selecting “Delete” may cause a currently displayed page of the print preview to be deleted. Selecting “Add” causes a new page to be added to the print preview. Selecting “Straighten” causes a currently displayed page of the print preview to be straightened if the page is tilted. Selecting “Crop” allows a user to crop the currently displayed page of the print preview. Selecting “Sign and Date” provides an option for a user to sign and date the currently displayed page of the print preview. Selecting “Markup” allows a user to annotate, highlight, or draw on the currently displayed page of the print preview. Selecting “Stamps” provides the user with an option to select one of a number of stamps to apply to the currently displayed page of the print preview. Selecting “Adjustments” allows a user to adjust a brightness of the currently displayed page of the print preview. Selecting “Undo” causes the last change to the print preview to be undone.

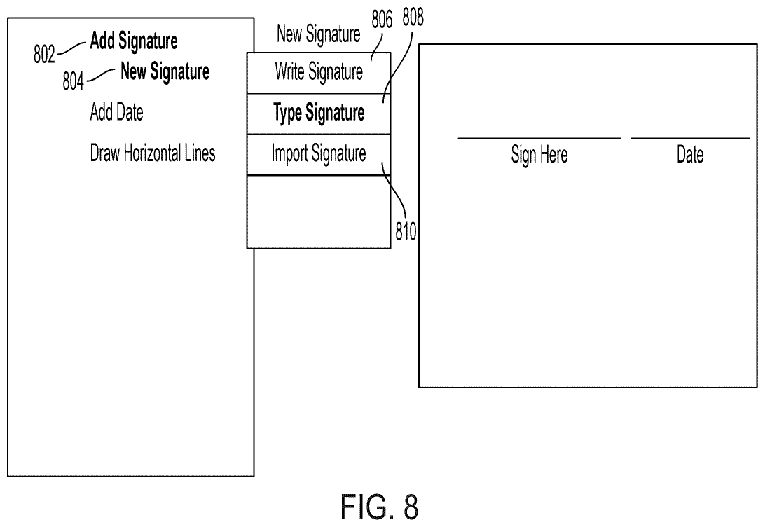

FIG. 8 is an example display that shows a signature being added to a document in an embodiment. When the user selects “Sign and Date” from the example display of FIG. 7, and then selects “Add Signature” 802 followed by selecting “New Signature” 804, the user may select “write signature” 806, “type signature” 808, or “import signature” 810. “Write signature” 806 would allow the user to write his or her name by movement of a pointing device. “Type signature” would allow the user to type his or her name. The typed name could be resized and moved by using the pointing to device to display the typed signature along a signature line. “Import signature” allows the user to import a signature, resize the signature to an appropriate size, and move the resized imported signature to display along a signature line.

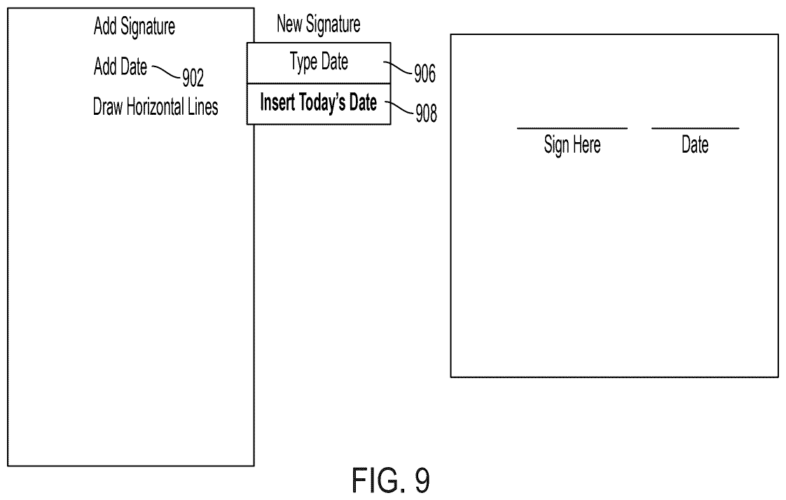

FIG. 9 shows a date being added to a page of a document. To add a date to a document while in a print path, a user would select “add date” 902”. After selecting “add date”, the user may select “type date” 906 or “insert today's date” 908. Selecting “add date” 906 would allow the user to type a date to be added to a currently displayed page of the print preview. Selecting “insert today's date” would cause today's date to be added to the currently displayed page of the print preview. The date could be resized and then moved by using a pointing device to display the typed date along a date line in the document.

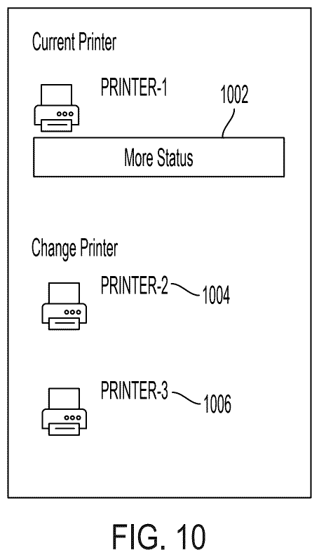

Another feature that may be implemented in various embodiments allows the user to change the printer while a document is in the print path. This feature could be initiated by selecting the printer from a display screen such as shown, for example, in FIG. 5 or 6. This would cause a fly-out menu to be displayed for changing to another printer. FIG. 10 shows an example display of a fly-out menu-in which “Printer-1” is shown as a current printer. A status of the current printer may be displayed by the user selecting “more status” 1002. In FIG. 10, the user may select “Printer-2” 1004 or “Printer-3” 1006 as the current printer by using, for example, a pointing device.

Embodiments of the subject matter of this disclosure have a number of advantages. For example, a PDF corresponding to a print job may be intercepted and provided to cloud applications to provide services such as language translation, creation of an audio file corresponding to text in the PDF file, creation of a summary from the PDF file based on artificial intelligence in the cloud, merging the PDF file with another PDF file, converting handwriting in the PDF file to text, providing for redaction of certain text in the PDF file, as well as may other services. In addition, other services may be provided while a document is in a print path such as, for example, adding of a signature and a date to a document, straightening of a document, cropping a document, marking up a document, stamping a document, and adjusting a brightness of a document.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for intercepting a print job and providing a user interface to allow a user to select one of a plurality of options to be performed, the method comprising:
intercepting, by a processor, the print job, the intercepting causing the print job to be paused;
displaying, by the processor, the user interface offering the user a selection of one of a plurality of options, the options including one or more of performing advanced previewing of the print job to alter a preview of the print job, and editing content of the print job;
receiving, from the user, the selection of the one of the plurality of options;
performing operations corresponding to the one of the selected plurality of options while the print job is in a print path; and
electronically distributing a document corresponding to the print job.

2. The method of claim 1, wherein the advanced previewing of the print job comprises an option to change one of a plurality of value-added print settings, the plurality of value-added print settings including a print setting regarding removal of a blank page and adding of a header or a footer to a page.

3. The method of claim 1, wherein the editing of the content of the print job includes one or more of highlighting at least one portion of the content, modifying text of the content, adding a signature to the content, and translating the content from a first language to a second language.

4. The method of claim 1, further comprising:
automatically sending the print job to a printer when the selection of the one of the plurality of options is not received during a predefined period of time after the displaying of the user interface.

5. The method of claim 1, wherein the electronically distributing the document comprises one of saving the document to disk, copying the document, storing the document in a cloud, sending the document to a printer, and emailing the document.

6. The method of claim 1, wherein when the user selects a control for printing the document, presenting via the user interface a plurality of first selectable controls for printing the document, editing the document, and showing a print preview of the document.

7. The method of claim 6, wherein when the user selects a first selectable control for showing the print preview of the document, the print preview of the document is presented and a plurality of second selectable controls is presented, the plurality of second selectable controls including a control for displaying and changing value-added print settings, a control for saving the document as a file, a control for copying the document to a clipboard, and a control for sharing the document with an application.

8. A system comprising:
at least one processor;
a respective memory connected with each of the at least one processor; and
a display device connected with one of the at least one processor, wherein a group of the respective memory connected with the each of the at least one processor collectively include processor instructions to perform operations comprising:
intercepting a print job, the intercepting causing the print job to be paused;
displaying, on the display device, a user interface offering the user a selection of one of a plurality of options, the options including one or more of performing advanced previewing of the print job to alter a preview of the print job, and editing content of the print job;
receiving, from the user, the selection of the one of the plurality of options;
performing operations corresponding to the selection of the one of the plurality of options while the print job is in a print path; and
electronically distributing a document corresponding to the print job.

9. The system of claim 8, wherein the advanced previewing of the print job comprises an option to change one of a plurality of value-added print settings, the plurality of value-added print settings including a print setting regarding removal of a blank page and adding of a header or a footer to a page.

10. The system of claim 8, wherein the editing of the content of the print job includes one or more of highlighting at least one portion of the content, modifying text of the content, adding a signature to the content, and translating the content from a first language to a second language.

11. The system of claim 8, wherein the operations further comprise:
automatically sending the print job to a printer when the selection of the one of the plurality of options is not received during a predefined period of time after the displaying of the user interface.

12. The system of claim 8, wherein the electronically distributing the document comprises one of saving the document to disk, copying the document, storing the document in a cloud, sending the document to a printer, and emailing the document.

13. The system of claim 8, wherein when the user selects a control for printing the document, presenting via the user interface a plurality of first selectable controls for printing the document, editing the document, and showing a print preview of the document.

14. The system of claim 13, wherein when the user selects a first selectable control for showing the print preview of the document, the print preview of the document is presented and a plurality of second selectable controls is presented, the plurality of second selectable controls including a control for displaying and changing value-added print settings, a control for saving the document as a file, a control for copying the document to a clipboard, and a control for sharing the document with an application.

15. A non-transitory computer-readable storage medium having instructions recorded thereon such that when the instructions are executed by one or more processors, operations are performed comprising:
intercepting a print job, the intercepting causing the print job to be paused;
displaying, on the display device, a user interface offering a user a selection of one of a plurality of options, the options including one or more of performing advanced previewing of the print job to alter a preview of the print job, and editing content of the print job;
receiving, from the user, the selection of the one of the plurality of options;
performing operations corresponding to the selection of the one of the plurality of options while the print job is in a print path; and
electronically distributing a document corresponding to the print job.

16. The non-transitory computer-readable storage medium of claim 15, wherein the advanced previewing of the print job comprises an option to change one of a plurality of value-added print settings, the plurality of value-added print settings including a print setting regarding removal of a blank page and adding of a header or a footer to a page.

17. The non-transitory computer-readable storage medium of claim 15, wherein the editing of the content of the print job includes one or more of highlighting at least one portion of the content, modifying text of the content, adding a signature to the content, and translating the content from a first language to a second language.

18. The non-transitory computer-readable storage medium of claim 15, wherein the electronically distributing the document comprises one of saving the document to disk, copying the document, storing the document in a cloud, sending the document to a printer, and emailing the document.

19. The non-transitory computer-readable storage medium of claim 15, wherein the operations further comprise:
presenting, via the user interface, a plurality of first selectable controls for printing the document, editing the document, and showing a print preview of the document when the user selects a control for printing the document.

20. The non-transitory computer-readable storage medium of claim 19, wherein when the user selects a first selectable control for showing the print preview of the document, the print preview of the document is presented and a plurality of second selectable controls is presented, the plurality of second selectable controls including a control for displaying and changing value-added print settings, a control for saving the document as a file, a control for copying the document to a clipboard, and a control for sharing the document with an application.
